(19) United States
(12) Patent Application Publication
(10) Pub. No.: US 2024/0312437 A1
(43) Pub. Date: Sep. 19, 2024

(54) MUSICAL INSTRUMENT

(71) Applicant: YAMAHA CORPORATION, Hamamatsu-shi (JP)

(72) Inventors: Shinji SUMINO, Hamamatsu-shi (JP); Yoshiya MATSUO, Hamamatsu-shi (JP)

(21) Appl. No.: 18/581,772

(22) Filed: Feb. 20, 2024

(30) Foreign Application Priority Data
Mar. 16, 2023 (JP) 2023-041958

(51) Int. Cl. G10C 3/06; G10C 3/12

(52) U.S. Cl. CPC G10C 3/06; G10C 3/12

(57) ABSTRACT

A musical instrument 1 according to an embodiment includes a sound board 7 configured to transmit a vibration of a sound source, and an exciter device 50 configured to vibrate the sound board 7 based on an input signal. The exciter device 50 includes a vibration exciter 51 disposed in contact with the sound board 7 and configured to vibrate the sound board 7, and a support part 52 attached to the sound board 7 and supporting the vibration exciter 51. The support part 52 includes an elastic displacement part 521 configured to be elastically displaced with respect to the sound board 7. The elastic displacement part 521's natural frequency is equal to or lower than a frequency corresponding to a highest peak among a plurality of peaks in a frequency characteristic of the vibration exciter 51.

### CROSS-REFERENCE TO RELATED APPLICATIONS

This application claims the benefit of priority to Japanese Patent Application No. 2023-041958, filed on Mar. 16, 2023, the entire contents of which are incorporated herein by reference.

### FIELD

The present disclosure relates to a musical instrument.

### BACKGROUND

Some musical instruments generate sound by vibrating a sound board or the like to which vibrations from a sound source are transmitted using a vibration exciter. As such a musical instrument, for example, Japanese Laid-Open Patent Publication No. 2012-150235 and Japanese Laid-Open Patent Publication No. 2017-129694 disclose a guitar having a vibration exciter attached on the body for vibrating the body. Further, Japanese Laid-Open Patent Publication No. 2014-142378 discloses a piano to which a vibration exciter for vibrating a sound board is attached.

### SUMMARY

According to an embodiment, there is provided a musical instrument including a sound board configured to transmit a vibration of a sound source, and a first exciter device configured to vibrate the sound board based on an input signal. The first exciter device includes a first vibration exciter disposed in contact with the sound board and configured to vibrate the sound board, and a support part attached to the sound board and supporting the first vibration exciter. The support part includes an elastic displacement part configured to be elastically displaced with respect to the sound board. The elastic displacement part's natural frequency is equal to or lower than a frequency corresponding to a highest peak among a plurality of peaks in a frequency characteristic of the vibration exciter.

### BRIEF DESCRIPTION OF DRAWINGS

FIG. 1 is a diagram showing an internal structure of a musical instrument according to an embodiment.

FIG. 2 is a diagram showing an example of an external appearance of an exciter device according to an embodiment.

FIG. 3 is a schematic cross-sectional view showing a cross section of the exciter device along A1-A2 line of FIG. 2.

FIG. 4 is a diagram showing an example of an attachment position of the exciter device in the musical instrument.

FIG. 5 is a graph showing a magnitude of a vibration of the exciter device according to an embodiment and a magnitude of a vibration of only a vibration exciter.

FIG. 6 is a graph showing a volume of a piano in the case where the exciter device according to an embodiment is attached to a sound board and a volume of the piano in the case where only the vibration exciter is attached to the sound board.

FIG. 7 is a graph showing the volume of the piano in the case where the exciter device according to an embodiment is attached to the sound board and the volume of the piano in the case where only the vibration exciter is attached to the sound board.

### DESCRIPTION OF EMBODIMENTS

In the case where a sound board of a musical instrument is vibrated by a vibration exciter, there is a problem that driving force of the vibration exciter is insufficient depending on a type of the musical instrument, a size or structure of the sound board of the musical instrument, or the like, and the sound board cannot be vibrated at a desired level. For example, in the case where the musical instrument is a piano, driving force of a small vibration exciter cannot vibrate the sound board at a desired level, particularly in low-frequency range. In the case where a large vibration exciter having high driving force is used, the vibration of the sound board is hindered by a weight of the vibration exciter itself, and sounds of the musical instrument are changed.

According to the present disclosure, it is possible to provide a musical instrument to which an exciter device having improved driving force is attached.

Hereinafter, an embodiment of the present disclosure will be described in detail with reference to the drawings. The following embodiments are examples, and the present disclosure should not be construed as being limited to these embodiments. In the drawings referred to in the present embodiment, the same or similar parts are denoted by the same reference signs or similar reference signs (only denoted by A, B, and the like after the numerals), and repetitive description thereof may be omitted. In order to clarify the explanation, the drawings may be explained schematically, with the dimensional ratios differing from the actual ratios, or with parts of the structure omitted from the drawings.

A musical instrument according to an embodiment of the present disclosure is capable of attaching a vibration exciter having a predetermined weight to an acoustic member. In the musical instrument according to the embodiment, an exciter device including the support part that supports the vibration exciter is attached to a sound board of the musical instrument. The support part supports the vibration exciter such that a portion of the vibration exciter is in contact with the sound board. The support part has an elastic displacement part that is elastic displaced with respect to the sound board. A vibration of the support part caused by the displacement of the elastic displacement part improves driving force of the exciter device.

Hereinafter, a musical instrument according to an embodiment will be described with reference to the drawings. In the embodiment described below, a case where the musical instrument is a keyboard musical instrument will be described as an example. In addition, the musical instrument according to the present disclosure is not limited to the keyboard musical instrument.

### [Composition of Music Instrument]

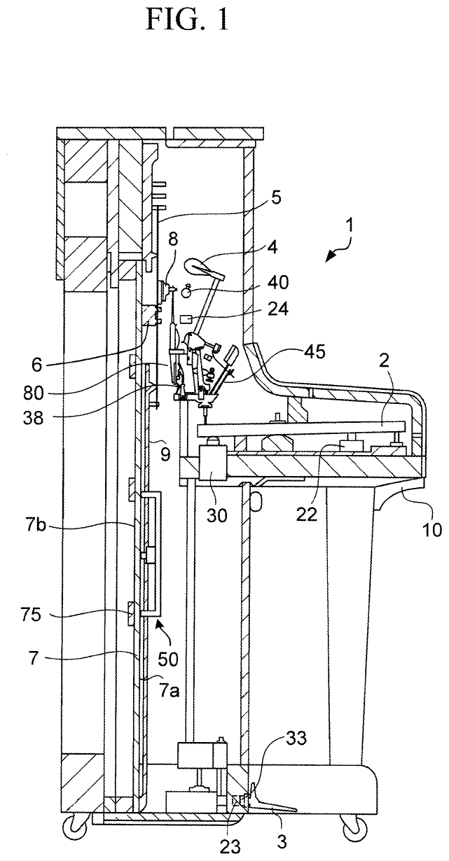

FIG. 1 is a diagram showing an internal structure of a keyboard musical instrument 1 according to the present embodiment. In the present embodiment, the keyboard musical instrument 1 is a piano. Hereinafter, the keyboard musical instrument 1 will be referred to as a piano 1. In the present embodiment, the piano 1 is an upright piano. The piano 1 is an example of a keyboard musical instrument having a keyboard in which a plurality of keys (performance operators) 2 for performing a performance operation by a player are arranged and a pedal 3. Although a plurality of pedals of the piano 1 exist, the pedal 3 indicates a damper pedal. In FIG. 1, a configuration provided corresponding to each of keys 2 is shown focusing on each configuration provided corresponding to one key 2 shown in FIG. 1 (in this example, a white key), and description of each configuration provided corresponding to other keys 2 is omitted.

The piano 1 has a control device 10. The control device 10 includes any one of an operation panel (not shown), a display part (not shown), and a touch panel (not shown). An instruction from a user is input to the control device 10 by operating the operation panel or the touch panel. The control device 10 controls an operation of each component of the piano 1 based on the instruction from the user.

A key drive device 30 that drives the key 2 using a solenoid may be arranged at a lower portion of a rear end side of each of the keys 2 (the rear side of the key 2 as viewed from a user who performs the key). The key drive device 30 drives the solenoid in response to a key control signal from the control device 10.

A hammer 4 is arranged corresponding to each of the keys 2. When the key 2 is pressed, a force is transmitted through an action mechanism 45 and the hammer 4 moves and strikes a string 5 arranged corresponding to each of the keys 2. The string 5 is a sound generating body that generates a sound by striking from the hammer 4. Strings 5 respectively have a vibration frequency corresponding to each of the keys 2.

A damper 8 is moved by a damper operation mechanism 80. A control of a contact state between the damper 8 and the string 5 is performed by the damper operation mechanism 80 in accordance with a depression amount of the key 2 and a depression amount of the pedal 3. The control of the contact state means that the damper 8 is moved in a range from a position where the damper 8 and the string 5 come into contact with each other to suppress a vibration of the string 5 (hereinafter, referred to as a vibration damping position) to a position where the string 5 is released from the damper 8 (hereinafter, referred to as a release position).

In the present embodiment, a damper drive device 38 for driving the damper operation mechanism 80 may be installed. The damper drive device 38 can drive the solenoid in response to a damper control signal from the control device 10.

Further, in the present embodiment, a pedal drive device 33 that drives the pedal 3 may be installed. The pedal drive device 33 can mechanically reproduce a state in which the pedal 3 is depressed by a player by driving the solenoid in response to a pedal control signal from the control device 10.

A stopper 40 is a member that collides with a hammer shank to prevent the hammer 4 from striking the string 5 before striking the string when a sound is generated by using a sound source. The stopper 40 moves to either a position where the stopper 40 collides with the hammer shank (hereinafter referred to as a block position) or a position where the stopper 40 does not collide with the hammer shank (hereinafter referred to as an avoidance position) in response to a stopper control signal from the control device 10.

A key sensor 22 is arranged at a lower portion of each of the keys 2. The key sensor 22 outputs a detection signal corresponding to a behavior of the key 2 to the control device 10. In this example, the key sensor 22 detects the depression amount of the key 2 with a continuous amount (fine resolution), and outputs the detection signal indicating a detection result to the control device 10. In addition, instead of outputting the detection signal corresponding to the depression amount of the key 2, the key sensor 22 may output a detection signal indicating that the key 2 has passed through a specific depression position. The specific depression position is any position in a range from a rest position to an end position of the key 2, and is desirably a plurality of positions that gives a change in a sound generation state such as a start of sound generation and a start of movement of the damper 8. As described above, the detection signal output from the key sensor 22 may be any signal as long as it allows the control device 10 to recognize the behavior of the key 2.

The hammer sensor 24 is arranged corresponding to each of hammers 4. The hammer sensor 24 outputs a detection signal corresponding to a behavior of the hammer 4 to the control device 10. In this example, the hammer sensor 24 detects a movement speed of the hammer 4 immediately before the strike to the string 5, and outputs the detection signal indicating a detection result to the control device 10. In addition, this detection signal does not necessarily indicate the movement speed of the hammer 4 itself, and the movement speed may be calculated by the control device 10 as a detection signal in another embodiment. For example, for two positions where the hammer shank passes while the hammer 4 is moving, a detection signal indicating that the hammer shank has passed may be output, or a detection signal indicating a time from passing through one position until passing through the other position may be output. As described above, the detection signal output from the hammer sensor 24 may be any signal as long as it allows the control device 10 to recognize the behavior of the hammer 4.

A pedal sensor 23 is arranged corresponding to each of pedals 3. The pedal sensor 23 outputs a detection signal corresponding to a behavior of the pedal 3 to the control device 10. In this example, the depression amount of the pedal 3 is detected, and a detection signal indicating a detection result is output to the control device 10. In addition, instead of outputting the detection signal corresponding to the depression amount of the pedal 3, the pedal sensor 23 may output a detection signal indicating that the pedal 3 has passed through a specific depression position. The specific depression position is preferably any position in a range from a rest position to an end position of the pedal, and is preferably a depression position in which a state in which the damper 8 and the string 5 are completely in contact with each other (vibration damping position) and a non-contact state (release position) can be distinguished from each other. As described above, the detection signal output from the pedal sensor 23 may be any signal as long as it allows the control device 10 to recognize the behavior of the pedal 3.

In addition, it is only necessary that the control device 10 be able to specify a strike timing of the hammer 4 with respect to the string 5 (timing of key-on), a strike speed (velocity), and a vibration suppression timing of the damper 8 with respect to the string 5 (timing of key-off) corresponding to each of the keys 2 (key number) by the detection signals output the key sensor 22, the pedal sensor 23, and from the hammer sensor 24. Therefore, the key sensor 22, the pedal sensor 23, and the hammer sensor 24 may output results of detecting the behaviors of the key 2, the pedal 3, and the hammer 4 as detection signals different from the embodiment described above. At least one of the key sensor 22, the pedal sensor 23, and the hammer sensor 24 may be omitted from the configuration of the piano 1.

In a sound board 7, a sound bar 75 and a bridge 6 are connected, and a vibration of the sound board 7 is transmitted to each of the strings 5 via the bridge 6, and the vibration of each of the string 5 is transmitted to the sound board 7 via the bridge 6. That is, the sound board 7 and the string 5 vibrate in a coupled manner. Here, a side to which the bridge 6 is connected is defined as a front surface 7a of the sound board 7, and the other side thereof is defined as a back surface 7b. An exciter device 50 is attached to the front surface 7a of the sound board 7. The exciter device 50 is attached to the sound board 7 such that a portion of the vibration exciter is directly on the front surface 7a of the sound board 7. Hereinafter, a configuration of the exciter device 50 will be described in detail.

### [Configuration of Exciter Device]

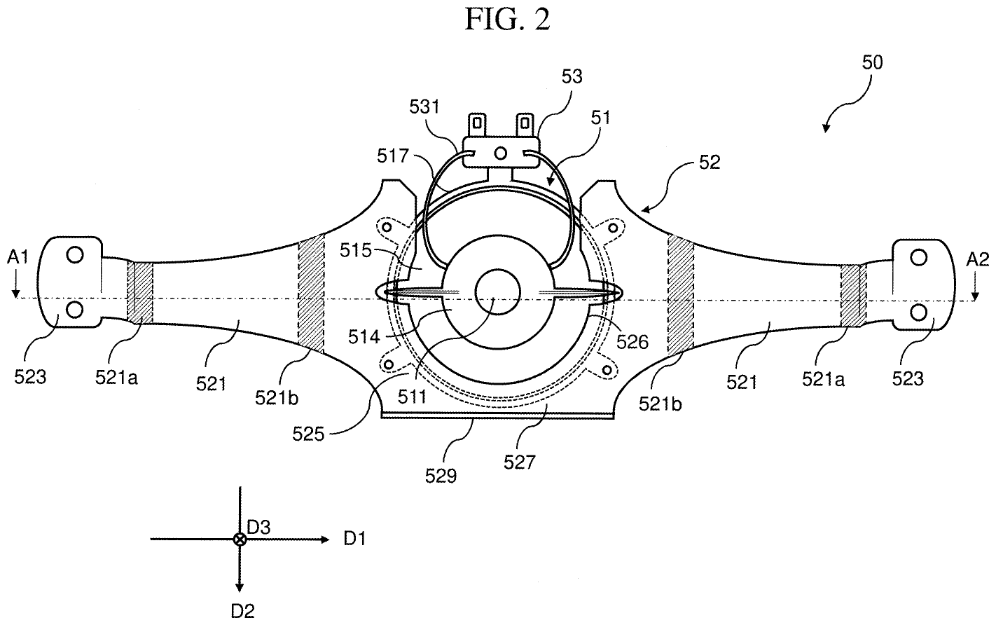

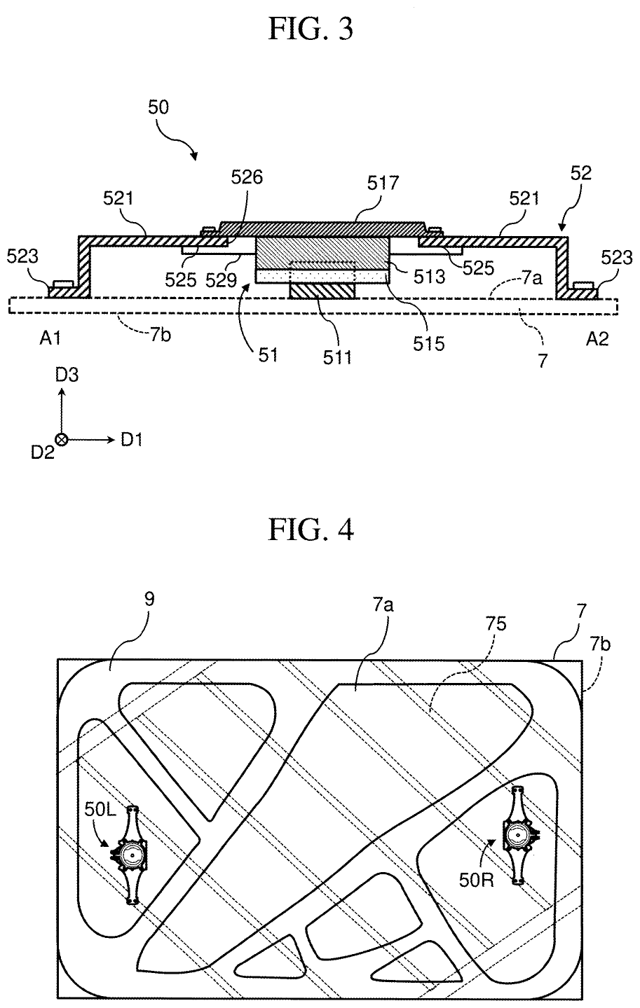

FIG. 2 is a diagram showing an example of an external appearance of the exciter device 50 according to the present embodiment. FIG. 2 shows the exciter device 50 viewed from the front surface 7a of the sound board 7. In other words, FIG. 2 shows one surface of the exciter device 50 facing the front surface 7a of the sound board 7. FIG. 3 is a schematic cross-sectional view showing a cross section of the exciter device 50 along an A1-A2 line of FIG. 2. In FIG. 3, a portion of a cap 514 shown in FIG. 2 is omitted.

The exciter device 50 includes a vibration exciter 51 and a support part 52 (bracket). The exciter device 50 may further include a terminal part 53. The vibration exciter 51 is in contact with the sound board 7 and vibrates the sound board 7. The support part 52 supports the vibration exciter 51 such that a portion of the vibration exciter 51 is in contact with the front surface 7a of the sound board 7. The support part 52 is attached to the sound board 7 and fixes the vibration exciter 51.

As shown in FIG. 2 and FIG. 3, the vibration exciter 51 includes a connection part 511, a displacement part 513, and a frame 517. The vibration exciter 51 is connected to an output device which is not shown in the drawing. The output device outputs an input signal for driving, which is generated based on at least one of music data stored in advance, acoustics/audio data, or the detection signals output from the key sensor 22, the pedal sensor 23, and the hammer sensor 24, to the vibration exciter 51. The output device may be connected to the terminal part 53 via a wiring which is not shown in the drawing. In this case, the vibration exciter 51 may receive the input signal output from the output device via the terminal part 53. The terminal part 53 supplies the drive signal output from the output device to the vibration exciter 51 via a wiring 531 that electrically connects the terminal part 53 and the vibration exciter 51. In addition, the vibration exciter 51 may be wirelessly connected to the output device. The vibration exciter 51 vibrates the sound board 7 in accordance with the input signal.

Specifically, the displacement part 513 is displaced with respect to the sound board 7 based on the input signal. In other words, the displacement part 513 vibrates in accordance with the input signal, and vibrates the sound plate 7 via the connection part 511.

As shown in FIG. 3, in the vibration exciter 51, an elastic part 515 is arranged between the displacement part 513 and the connection part 511. The elastic part 515 guides a vibration of the connection part 511. The elastic part 515 has flexibility. The elastic part 515 may be formed of a resin material, a metal material, or the like.

As shown in FIG. 2, the cap 514 of resin or the like is attached to a side of the vibration exciter 51 facing the sound board 7. The cap 514 includes the connection part 511 that contacts the sound board 7. The connection part 511 makes contact with the sound board 7 and vibrates the sound board 7. The cap 514 including the connection part 511 is formed of a light material such as a resin such as polyimide or a metal such as aluminum. In FIG. 3, a configuration of the cap 514 excluding the connection part 511 is omitted.

For example, the vibration exciter 51 may be a voice coil type actuator. In this case, the displacement part 513 has a magnetic body part, and the connection part 511 moves integrally with a voice coil. A weight of the displacement part 513 is heavier than a weight of the connection part 511. As a result, the connection part 511 can be vibrated by a vibration of the displacement part 513.

The frame 517 is in contact with the displacement part 513. In addition, a portion of the displacement part 513 may be accommodated in the frame 517. The frame 517 and the displacement part 513 are bonded to each other with an adhesive, a double-sided tape (not shown), or the like. In addition, the connection part 511 and the frame 517 may not be directly bonded to each other, but may be connected to each other via a relay member for detachably fixing the connection part 511 and the frame 517. The frame 517 is fixed to the support part 52 by screwing. However, a method for fixing the frame 517 to the support part 52 is not limited to screwing. The frame 517 is made of a resin such as polyimide.

The support part 52 fixes the vibration exciter 51 so that the connection part 511 of the vibration exciter 51 is in contact with the sound board 7. The support part 52 is a one-piece bracket having a plate-shaped part having a length in a predetermined first direction D1. The support part 52 is made of a metal such as iron or stainless steel, a resin, or the like. The support part 52 is connected to the displacement part 513 of the vibration exciter 51 via the frame 517. The support part 52 includes an elastic displacement part 521, a fixed part 523, and a vibration exciter attachment part 525.

Referring to FIG. 2, the support part 52 has the vibration exciter attachment part 525 to which the vibration exciter 51 is attached at the center. An end portion of the vibration exciter attachment part 525 in the first direction D1 connects to the elastic displacement part 521. The elastic displacement part 521 is a plate-shaped part having a length in the first direction D1. One end 521a (first end) of the elastic displacement part 521 is connected to the fixed part 523. In other words, the fixed part 523 is connected to the one end 521a (first end) of the elastic displacement part 521, and the vibration exciter attachment part 525 is connected to the other end 521b (second end).

The elastic displacement part 521 has flexibility and vibrates by the vibration of the displacement part 513. In other words, the elastic displacement part 521 is elastic displaced with respect to the sound board 7. The elastic displacement part 521's a natural frequency is equal to or less than a frequency corresponding to a highest peak among a plurality of peaks in a frequency characteristic of the vibration exciter 51. Here, the highest peak among the plurality of peaks is the highest peak on a low frequency band side. Specifically, the “low frequency band side” is a frequency band equal to or less than 1000 Hz (1 kHz). That is, the elastic displacement part 521's natural frequency is equal to or less than a frequency corresponding to the highest peak equal to or less than 1000 Hz among the plurality of peaks in the frequency characteristic of the vibration exciter 51. Specifically, the elastic displacement part 521's natural frequency is in a frequency band between 100 Hz and 200 Hz. The elastic displacement part 521's natural frequency can be adjusted by adjusting a length, a width, a thickness, and the like of the elastic displacement part 521. Here, the length of the elastic displacement part 521 is a length in the first direction D1. The width of the elastic displacement part 521 is a width in a second direction D2 perpendicular to the first direction D1. The thickness of the elastic displacement part 521 is a thickness in a third direction D3 perpendicular to the first direction D1 and the second direction D2.

The fixed part 523 is attached to the sound board 7, and fixes the entire support part 52 to the sound board 7. The fixed part 523 is attached to the sound board 7 by screwing. However, a method of attaching the fixed part 523 to the sound board 7 is not limited to screwing, and the fixed part 523 may be bonded to the sound board 7 by an adhesive, a double-sided tape (not shown), or the like. In addition, the fixed part 523 and the sound board 7 may not be directly bonded to each other, but may be connected to each other via a relay member for detachably fixing the fixed part 523 and the sound board 7. The fixed part 523 is connected to the one end 521a of the elastic displacement part 521. As shown in FIG. 2, the fixed part 523 may have a bent portion that is bent along the third direction D3 from the one end 521a of the elastic displacement part 521, and a flat portion connected to the bent portion and extending along the first direction D1.

The vibration exciter 51 is attached to the vibration exciter attachment part 525. The vibration exciter attachment part 525 has an opening 526 for exposing the connection part 511 of the vibration exciter 51 to the sound board 7 side. The opening 526 may be open on a side where the terminal part 53 is arranged in order to secure a space for arranging the wiring 531 electrically connecting the terminal part 53 and the vibration exciter 51.

The vibration exciter attachment part 525 has a vibration exciter support part 527 at an end portion in the second direction D2. The vibration exciter support part 527 has higher stiffness than the elastic displacement part 521 with respect to a direction in which the elastic displacement part 521 is displaced, that is, the third direction D3. For example, a thickness of the vibration exciter support part 527 in the third direction D3 may be larger than the thickness of the elastic displacement part 521. Further, as shown in FIG. 2, a bent part 529 that is bent in the third direction D3 may be arranged at an end portion of the vibration exciter support part 527 in the second direction D2. The bent part 529 improves the stiffness of the vibration exciter support part 527. Since the vibration exciter support part 527 has the higher stiffness than the elastic displacement part 521 with respect to the third directional D3, the vibration exciter 51 is stably held when the vibration exciter 51 is attached to the vibration exciter attachment part 525.

FIG. 4 is a diagram showing an example of an attaching position of the exciter device 50 in the piano 1. As shown in FIG. 4, a frame 9 is arranged on the front surface 7a of the sound board 7, and strings (not shown) are installed. A bridge (not shown) is connected to the front surface 7a. A plurality of sound bars 75 are arranged at a predetermined distance from each other on the back surface 7b which is the opposite side of the front surface 7a. The exciter device 50 is attached to the front surface 7a of the sound board 7 such that the connection part 511 of the vibration exciter 51 is in contact with the front surface 7a of the sound board 7. As shown in FIG. 4, the exciter device 50 may be attached such that the connection part 511 of the vibration exciter 51 is in contact with a region located between neighboring sound bars 75 on the front surface 7a of the sound board 7. In this case, the fixed part 523 of the support part 52 of the exciter device 50 may be fixed to the sound board 7 so as to be overlapped the sound bar 75 attached on the back surface 7b of the sound plate 7.

In the present embodiment, the piano 1 includes two exciter devices 50, an exciter device 50L attached to a low-frequency range side of the piano 1 (left side of the sound board 7 shown in FIG. 4) and an exciter device 50R attached to a high-frequency range side (right side of the sound board 7 shown in FIG. 4). The exciter devices 50 (50L and 50R) are preferably attached at a position where the sound board 7 and the frame 9 do not overlap and strings (not shown in FIG. 4) are not installed in view of convenience in attaching on the sound board 7. In addition, the positions at which the exciter devices 50 (50L and 50R) are attached to the sound board 7 are not limited to the positions shown in FIG. 4, and can be appropriately set in accordance with a configuration of the frame 9, an installation position of the string, and the like.

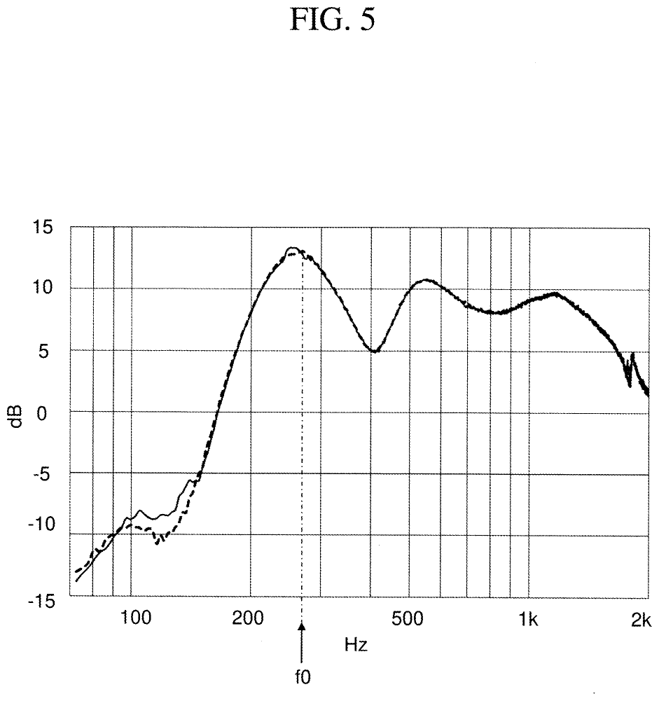

FIG. 5 is a diagram showing a magnitude of a vibration of the exciter device 50 according to the present embodiment and a magnitude of a vibration of the vibration exciter 51 in a range from 70 Hz to 2000 Hz (2 kHz). Hereinafter, the vibration exciter 51 in which the support part 52 is omitted will be referred to as a comparative vibration exciter. In the graph shown in FIG. 5, a frequency (Hz) is shown on a horizontal axis and a vibration level (dB) is shown on a vertical axis, a frequency characteristic of the exciter device 50 is shown by a solid line, and a frequency characteristic of the comparative vibration exciter is shown by a dashed line. Here, as a vibration exciter in the exciter device 50 and a comparator vibration exciter, an actuator having a weight of about 109.5 g, a rated input of 15 W (maximum input 30 W), a rated impedance of 4Ω, an impedance of about 4.4Ω at 700 Hz, a minimum resonance frequency (f0) of about 215 Hz at 1 V, and a magnetic flux density of about 1.20 T was used. As the exciter device 50, a support part (bracket) to which the vibration exciter is attached was used together with the vibration exciter described above. The support part (bracket) had the same configuration as the support part 52 shown in FIG. 2, and a resonance frequency of a primary mode of an elastic displacement part was 119.45 Hz. In other words, the elastic displacement part of the support part (bracket) has a natural frequency that is equal to or less than a frequency (about 215 Hz) corresponding to the highest peak (f0) of a frequency characteristic of the vibration exciter.

As shown in FIG. 5, in a region of 100 Hz to 200 Hz, the magnitude of the vibration of the exciter device 50 indicated by the solid line is larger than a magnitude of a vibration of the comparative vibration exciter indicated by the dashed line. In other words, in the range of 100 Hz to 200 Hz, in particular in a range of about 100 Hz to about 160 Hz, a driving force of the exciter device 50 exceeds a driving force of the comparative vibration exciter. As a result, it can be seen that a vibration of the support part (bracket) attached to the vibration exciter contributes to the improvement of the driving force of the entire exciter device 50.

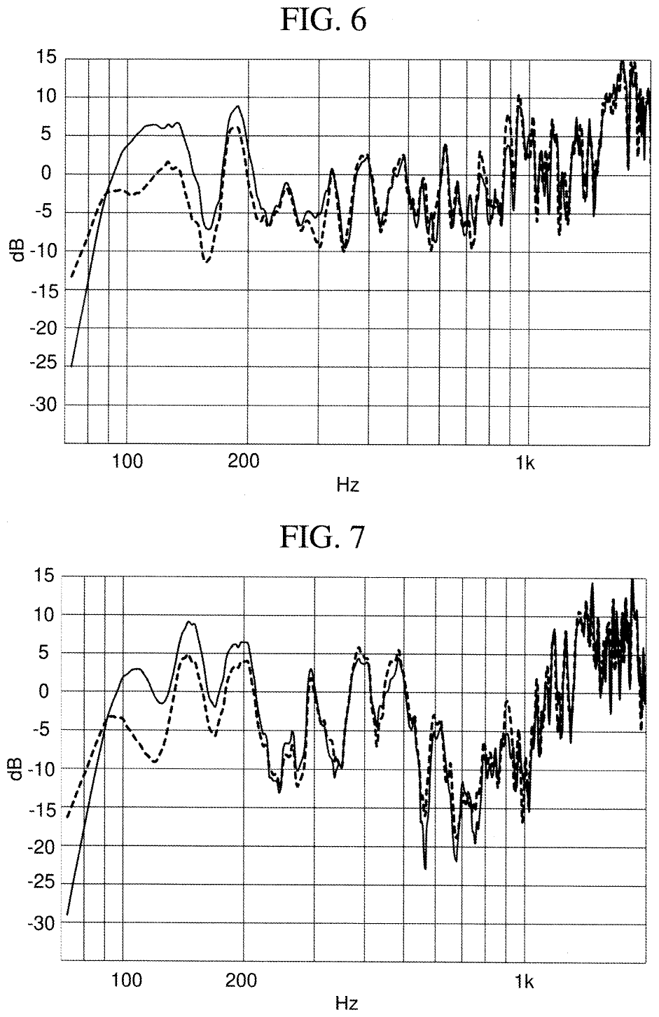

FIG. 6 and FIG. 7 are graphs showing a frequency dependence of a sound volume of the piano in the case where the exciter device 50 according to the present embodiment is attached on the sound board and driven, and in the case where the comparative vibration exciter is attached on the sound board and driven. An upright piano was used as the piano, and sound pressure of the piano was measured using a microphone at a position of the player of the piano, that is, substantially in front of the piano. Characteristics of the exciter device 50 and the comparative vibration exciter used here are the same as those of the exciter device 50 and the comparative vibration exciter used in the measurement of the vibration of the sound board shown in FIG. 5. Further, as shown in FIG. 4, the exciter device 50 or the comparative vibration exciter was installed at two locations on the sound board of the piano.

FIG. 6 is a graph showing frequency dependence of the sound volume of a piano in which the exciter device 50L or a comparative vibration exciter is arranged in the low-frequency range side of the piano shown in FIG. 4. In the graph shown in FIG. 6, a horizontal axis represents a frequency (Hz) and a vertical axis represents a vibration level (dB), the solid line represents the sound volume of the piano in the case where the exciter device 50 is attached to the sound board, and the dashed line represents the sound volume of the piano in the case where the comparative vibration exciter is attached to the sound board. FIG. 7 is a graph showing frequency dependence of the sound volume of a piano in which the exciter device 50R or the comparative vibration exciter is arranged in the high-frequency range side of the piano. In the graph shown in FIG. 7, a horizontal axis represents a frequency (Hz) and a vertical axis represents a vibration level (dB), the solid line represents the sound volume of the piano in the case where the exciter device 50 is attached to the sound board, and the dashed line represents the sound volume of the piano in the case where the comparative vibration exciter is attached to the sound board.

As shown in FIG. 6 and FIG. 7, the sound volume of the piano in the case where the exciter devices 50 (50L and 50R) indicated by the solid line is attached to the sound board is higher than the sound volume of the piano in the case where the comparative vibration exciters indicated by the dashed line is attached to the sound board in both the low-frequency and high-frequency sides of the piano in 100 Hz to 200 Hz range. Therefore, it can be seen that acoustic characteristics of the piano are improved in the case where the exciter device 50 is attached to the sound board. Further, as shown in FIG. 6 and FIG. 7, by attaching the exciter device 50 to the sound board, it is possible to improve the acoustic characteristics of the piano, particularly on the low-frequency side.

As described above, in the exciter device 50, by arranging the support part 52 (bracket) that supports the vibration exciter 51 with the elastic displacement part 521 that is elastic displaced with respect to the sound board, the driving force of the entire exciter device 50 can be improved. By attaching the exciter device 50 to the sound board 7 of the piano 1, it is possible to improve the acoustic characteristics of the piano 1, particularly the acoustic characteristics on the low-frequency side.

### Modifications

Although an embodiment of the present disclosure has been described above, the present disclosure can be implemented in various aspects as follows.

(1) In the embodiment described above, a case in which the present disclosure is applied as a keyboard musical instrument has been described. Here, the keyboard musical instrument is not limited to the upright piano, and may be, for example, a grand piano, a clavi code, or the like. Further, the present disclosure is not limited to a keyboard musical instrument, and may be a sound device that does not include an operator such as a key.

(2) In the embodiment described above, an example has been described in which the two exciter devices 50 are attached to the sound board 7 as shown in FIG. 4. However, the number of exciter devices 50 attached to the sound board 7 is not limited to two, and one or three or more exciter devices 50 may be attached.

(3) The same input signal may be input to the plurality of exciter devices 50, or different input signals may be input to the plurality of exciter devices. For example, in the case where two exciter devices 50 are used, the input signal corresponding to each of them may be an input signal for the exciter device 50 (50L) arranged on the low-frequency range side and an input signal for the exciter device 50 (50R) arranged on the high-frequency range side.

(4) Further, the frequency characteristics of the plurality of exciter devices 50 may be different. For example, the resonance frequency of the elastic displacement part 521 of the exciter device 50 (50R) arranged on the high-frequency range side may be higher than the resonance frequency of the elastic displacement part 521 of the exciter device 50 (50L) arranged on the low-frequency range side.

What is claimed is:

1. A musical instrument comprising:
a sound board configured to transmit a vibration of a sound source; and
a first exciter device configured to vibrate the sound board based on an input signal, the first exciter device comprising:
a first vibration exciter disposed in contact with the sound board and configured to vibrate the sound board; and
a support part attached to the sound board and supporting the first vibration exciter, the support part including an elastic displacement part configured to be elastically displaced with respect to the sound board,
wherein the elastic displacement part's natural frequency is equal to or lower than a frequency corresponding to a highest peak among a plurality of peaks in a frequency characteristic of the first vibration exciter.

2. The musical instrument according to claim 1, wherein the input signal is generated based on a signal indicating the vibration of the sound source.

3. The musical instrument according to claim 1, wherein:
the support part further includes:
a fixed part disposed at a first end of the elastic displacement part and attached to the sound board; and
a vibration exciter attachment part disposed at a second end of the elastic displacement part located on an opposite side of the first end, and attached to the first vibration exciter,
the vibration exciter attachment part includes a vibration exciter support part extending from the second end, and
the vibration exciter support part has a higher rigidity with respect to a direction of displacement of the elastic displacement part than the elastic displacement part.

4. The musical instrument according to claim 1, wherein the vibration exciter support part includes a folded part bent, toward the sound board, to increase rigidity.

5. The musical instrument according to claim 1, wherein the natural frequency of the elastic displacement part is in a frequency band between 100 Hz and 200 Hz.

6. The musical instrument according to claim 1, further comprising a second exciter device including a second vibration exciter vibrating the sound board, wherein the frequency characteristic of the first vibration exciter and a frequency characteristic of the second vibration exciter are different from each other.

7. The musical instrument according to claim 1, further comprising a plurality of keys, wherein the sound source emits a sound based on an operation on each of the plurality of keys.

8. The musical instrument according to claim 1, wherein the musical instrument is a piano.

9. A vibration exciter device for a musical instrument including a sound board, the vibration exciter comprising:
a vibration exciter configured to be disposed in contact with the sound board and vibrate the sound board based on an input signal; and
a support bracket configured to hold the vibration exciter and mount to the sound board,
wherein the support includes an elastic displacement part configured to be elastically displaced with respect to the sound board, in a state where the support bracket is mounted to the sound board, and
wherein the elastic displacement part's natural frequency is equal to or lower than a frequency corresponding to a highest peak among a plurality of peaks in a frequency characteristic of the vibration exciter.

10. The vibration exciter device according to claim 9, where the musical instrument is a piano.
